(19) United States
(12) Patent Application Publication
(10) Pub. No.: US 2009/0017658 A1
(43) Pub. Date: Jan. 15, 2009

(54) Electrical connector with an ejecting device

(75) Inventor: Fang-Chu Liao, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/217,213

(22) Filed: Jul. 1, 2008

(30) Foreign Application Priority Data
Jul. 10, 2007 (CN) 200720040638.3

(51) Int. Cl. H01R 13/62

(52) U.S. Cl. 439/160

(57) ABSTRACT

A socket connector for connecting an IC package to a printed circuit board includes an insulating base (6) defining a mating face (61) and a plurality of terminal grooves (65) therethrough in a first direction perpendicular to the mating face. A plurality of conductive terminals (7) is retained in the terminal grooves (65) for electrically contacting with corresponding pins of the IC package when the IC package is assembled on the insulating base. A pair of ejecting devices (67) each includes an ejecting portion (675) projecting into the insulating base (6) and an operating portion (674) extending outward of the insulating base. The ejecting portion (675) moves beyond the mating face (61) in the first direction when an exterior force is applied on the operating portion (674) to press the operating portion (674) away from the mating face (61), so as to eject the IC package out of the insulating base.

### BACKGROUND OF THE INVENTION

1. Field of the Invention

The present invention relates to an electrical connector, and particularly to a socket connector for connecting an IC package to a printed circuit board (PCB).

2. Description of the Prior Art

FIGS. 1 and 2 disclose a conventional socket connector 1′ for connecting an IC package 2′ to a PCB. The socket connector 1′ has a rectangular insulating base 3′ for connecting with the IC package 2′. The base 3′ is excavated in a middle portion, thereby defines an opening 32′ therein. A plurality of terminal grooves 33′ is respectively defined at opposite end portions of the base 3′ for receiving a plurality of conductive terminals 4′. The IC package 2′ has a plurality of pins 23′ to be inserted into the corresponding grooves 33′ and to electrically contact with the conductive terminals 4′. However, when the IC package 2′ is withdrawn from the insulating base 3′ by an exterior force, the plurality of pins 23′ will suffer a different force and may result in breakage of the pins 23′. Hence, a new design which can solve the problem is required.

### SUMMARY OF THE INVENTION

Accordingly, an object of the present invention is to provide a socket connector with an ejecting device and the ejecting device help extraction process of an IC package assembled in the socket connector.

In order to achieve the object set forth, a socket connector for connecting an IC package to a printed circuit board includes an insulating base defining a mating face and a plurality of terminal grooves therethrough in a first direction perpendicular to the mating face. A plurality of conductive terminals is retained in the terminal grooves for electrically contacting with corresponding pins of the IC package when the IC package is assembled on the insulating base. A pair of ejecting devices each includes an ejecting portion projecting into the insulating base and an operating portion extending outward of the insulating base. The ejecting portion moves beyond the mating face in the first direction when an exterior force is applied on the operating portion to press the operating portion away from the mating face, so as to eject the IC package out of the insulating base.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded perspective view of a conventional socket connector and an IC package;

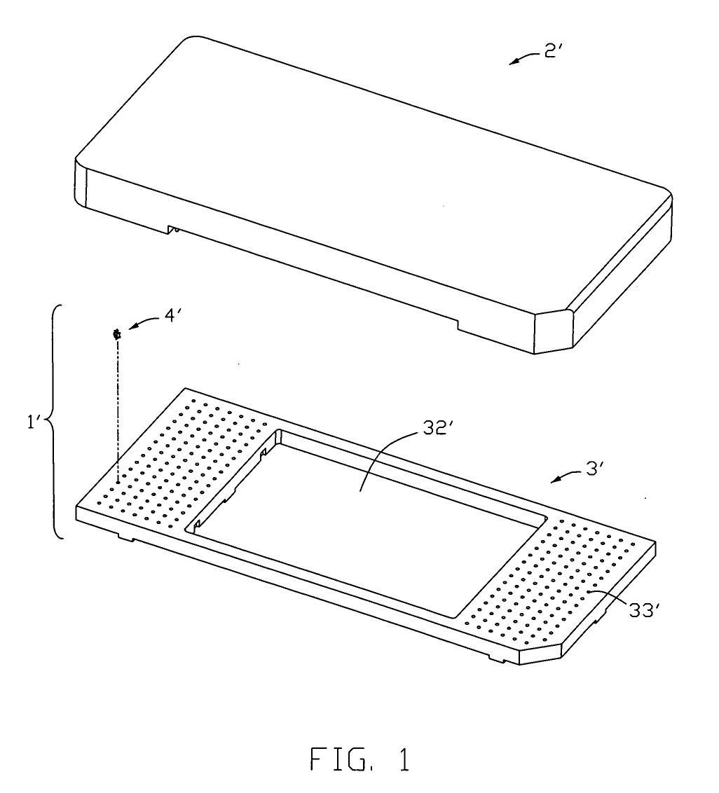

FIG. 2 is a schematic view of the socket connector shown in FIG. 1 with the IC package mounted thereon;

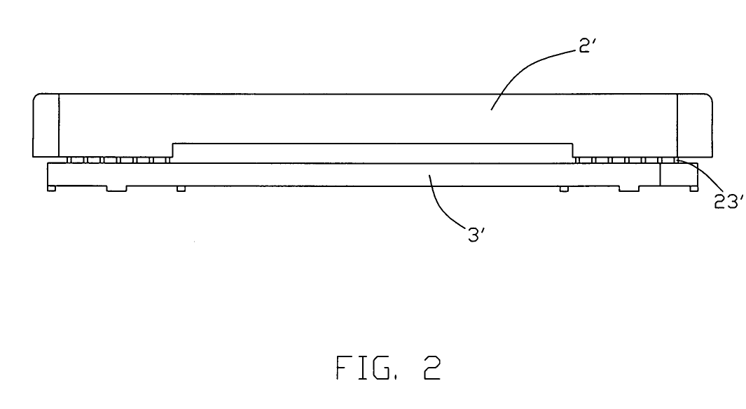

FIG. 3 is a perspective view of a socket connector according with the present invention;

FIG. 4 is a perspective view of the socket connector with an IC package mounted thereon; and

FIG. 5 is a cross sectional view of FIG. 4 along line 5-5, which substantially shows the status of the IC package being ejected out of the socket connector.

### DETAILED DESCRIPTION OF THE INVENTION

Reference will now be made to the drawing figures to describe a preferred embodiment of the present invention in detail.

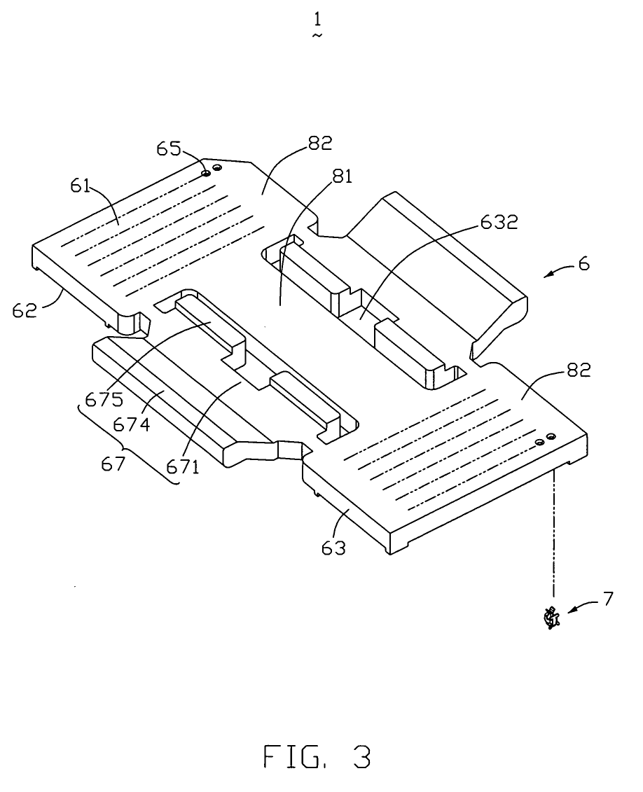

Referring to FIG. 3, a socket connector 1 in accordance with the present invention is provided and comprises an insulating base 6 with a plurality of conductive terminals 7 mounted therein.

The insulating base 6 is a rectangular shape and has a top face 61 and a bottom face 62 parallel and opposite to the top face. The insulating base 6 is divided into three parts in a longitudinal direction, which forms a middle portion 81 and a pair of end portions 82. The end portion 82 defines a plurality of terminal grooves 65 through the top and bottom faces for receiving the conductive terminals 7, the end portions being functioning as mating portions and the top face being severing as a mating face, the bottom face severing as a mounting face.

Referring to FIG. 3, the mating portion 82 is larger than the middle portion 81 in a transverse direction perpendicular to the longitudinal direction. A pair of ejecting devices 67 are respectively integrally defined in an opening 632 among the middle portion 81 and two mating portions 82. Each ejecting device 67 comprises a base portion 671 located at a same level of the top face of the base, integrally joined with the periphery walls of the mating portions 82 at opposite ends thereof, an ejecting portion 675 facing inwardly and projecting upwardly slightly higher than the top face 61, and an operating portion 674 extending from an outward edge of base portion 671 and then slantwise protruding upwardly and beyond the sidewall 63. The operating portion 674 and ejecting portion 675 are spaced away the side walls of the mating portions.

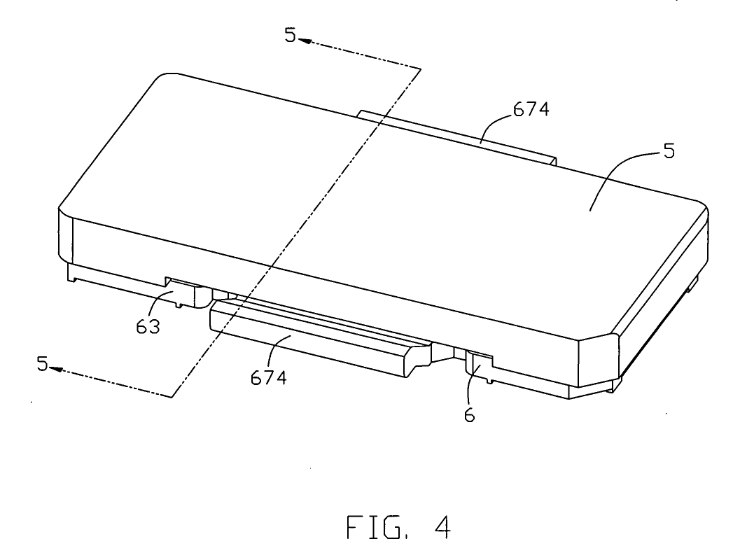

Referring to FIG. 4, the IC package 5 is assembled on the socket connector 1 after the conductive terminals 7 inserted into the receiving grooves 65. The IC package 5 has a plurality of pins inserted into the receiving grooves 65 in a perpendicular direction so as to electrically contact with the conductive terminals 7.

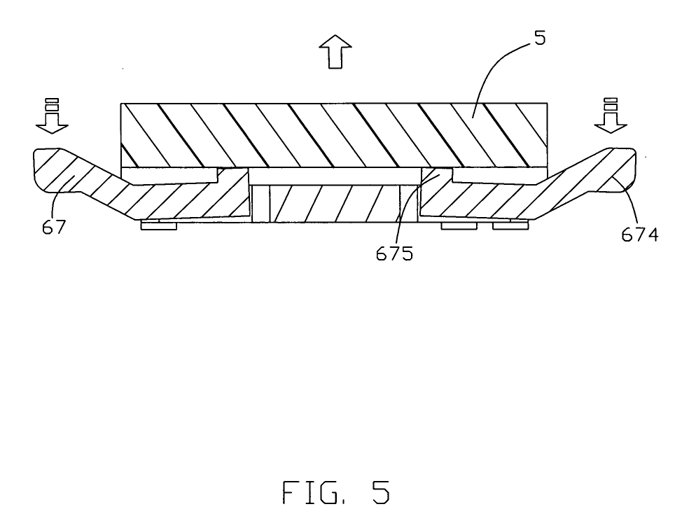

Referring to FIG. 5, when the IC package 5 is need to be withdrawn from the base 6, the operating portion 674 is pressed to move downwardly by an exterior force, as the base portion 671 serves as a fulcrum lever due to the leverage principle, the ejecting portion 675 is moving upwardly to press against the IC package 5, thereby pushing the pins of the IC package 5 out of the receiving grooves 65.

The ejecting portion 675 and the operating portion 674 move in a reverse direction along the perpendicular direction when an exterior force is applied on the operating portion, which can avoid the breakage of the pins of the IC package 5 when the IC package is directly pulled out of the insulating base 6.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A socket connector for connecting an IC package to a printed circuit board (PCB) comprising:
an insulating base defining a mating face and a plurality of terminal grooves therethrough in a first direction perpendicular to the mating face;
a plurality of conductive terminals retained in the terminal grooves for electrically contacting with corresponding pins of the IC package when the IC package is assembled on the insulating base; and
a pair of ejecting devices, each comprising an ejecting portion projecting into the insulating base and an operating portion extending outward of the insulating base;
wherein the ejecting portion moves beyond the mating face in the first direction when an exterior force is applied on the operating portion to press the operating portion away from the mating face, so as to eject the IC package out of the insulating base.

2. The socket connector as described in claim 1, wherein the ejecting device further comprises a base portion integrally formed with the insulating base, the operating portion and the ejecting portion are respectively arranged at opposite sides of the base portion.

3. The socket connector as described in claim 2, wherein the ejecting portion projects beyond the mating face.

4. The socket connector as described in claim 3, wherein the operating portion extends outward from the base portion and slantwise projects upwardly.

5. The socket connector as described in claim 1, wherein the insulating base comprises a pair of mating portions joined by a middle portion in a longitudinal direction, the middle portion is shorter than the mating portions in a transverse direction perpendicular to the longitudinal direction, and the ejecting devices are formed on the middle portion.

6. The socket connector as described in claim 5, wherein the ejecting device further comprises a base portion integrally jointed with periphery walls of the mating portions.

7. A socket connector comprising:
an insulating base defining a pair of mating portions with a plurality of terminal grooves therethrough and a middle portion connecting with said mating portions;
a plurality of conductive terminals received in the terminal grooves; and
a pair of ejecting devices disposed between the two mating portions, each comprising a base portion joined with insulating base and serving as a fulcrum level, an operating portion and an ejecting portion formed at opposite sides of the base portion;
wherein the operating portion is pressed downwards and the ejecting portion is urged to upwardly shift.

8. The socket connector as described in claim 7, wherein the ejecting device is formed on the middle portion of the insulating base, and the ejecting portion projects beyond the middle portion of the base.

9. The socket connector as described in claim 8, wherein the operating portion extends outward from the base portion and spaces away periphery walls of the mating portions.

10. An electrical connector for use with an electronic package, comprising:
an insulative housing configured to couple to said electronic package in a size-compliant manner where the electronic package is mounted thereon, and defining two opposite contact regions linked by a middle portion therebetween,
an ejecting mechanism located between said contact regions beside the middle portion, said ejecting mechanism including an inner ejecting portion, which is within a contour of the electronic package, and an outer pressing portion, which is located outside of said contour of the electronic package, to commonly form a lever type operation via vertical engagement between the ejecting portion and an underside of the electronic package during removing the electronic package from the housing.

11. The electrical connector as claimed in claim 10, wherein said ejecting mechanism is unitarily formed with the housing.

12. The electrical connector as claimed in claim 10, wherein there is another ejecting mechanism located by the other side of said middle portion opposite to said ejecting mechanism in a transverse direction.

13. The electrical connector as claimed in claim 10, wherein said housing defines a long side and a short side, and the ejecting mechanism is located on said long side.
